(19) United States
(12) Patent Application Publication
(10) Pub. No.: US 2006/0011799 A1
(43) Pub. Date: Jan. 19, 2006

(54) Fixing means for cards and components

(76) Inventor: Bruno Coissac, Asnieres/Seine (FR)

Correspondence Address: Bruno Coissac, 258 Avenue D'Argenteuil, Asnieres Sur Seine, 92600, FR

(21) Appl. No.: 10/519,566

(22) PCT Filed: Jun. 11, 2003
(86) PCT No.: PCT/FR03/01731

§ 371 Date: Jul. 25, 2005

(30) Foreign Application Priority Data
Aug. 2, 2002 (FR) 02/09853
Oct. 21, 2002 (FR) 02/13080
May 26, 2003 (WO) PCT/FR03/01581

(51) Int. Cl. F16M 13/00

(52) U.S. Cl. 248/560

(57) ABSTRACT

The invention relates to a dumping fixing means for components and cards supporting a printed circuit and components. Said means is characterised in that, once mounted, said means has a flexible part (PS) between the ends (EX) thereof and arrangements for facilitating the use thereof. In particular, said means is suitable for reducing the risk of failure in electrical and electronic systems. The above may be used as a replacement for or in addition to conventional or non-conventional fixing means.

This invention concerns a shock-absorbing means of attachment or shock-absorbing complement for a means of attachment for components and printed circuit and component support boards.

It may, depending on its mode of production, be used as a complement for or as a replacement for conventional or non-conventional means of attachment.

Components and printed circuit and component support boards are generally attached to each other and to the box or system which houses them by rigid means of attachment.

Such boards are thus subjected to any impacts and deformations which may be applied to these boxes or systems.

Micro-breaks can be produced on the printed circuit tracks because the energy of an impact or vibration is transmitted to them largely or even entirely, as is also the case when thermal variations cause expansions and contractions of the accommodating box or system.

If we place, between the component or the printed circuit support board and the accommodating box or system, one or more means of attachment each comprising a flexible part or parts linking at least two of their ends equipped for attachment and if, once installed, this means of attachment presents a flexible part or parts and never a rigid part linking, via one of these two equipped ends, the component or the board to the system or box by way of the second of these two equipped ends, the impacts and deformations to which the accommodating box or system is subjected are damped and largely absorbed before being transmitted to the component or to the printed circuit and component support board.

The shock-absorbing means of attachment or shock-absorbing complement for a means of attachment according to this invention reduces the risks of breakdown for systems which are fixed, mobile or liable to be moved and which may be exposed to vibrations, impacts, deformations and/or thermal variations.

The shock-absorbing means of attachment or shock-absorbing complement for a means of attachment according to this invention comprises at least two ends each equipped for attachment, each or only one of them being able to receive independently, in whole or in part, a separate means of attachment, whether conventional or non-conventional, and each or only one second end constituting by its shape a conventional or non-conventional separate means of attachment.

For the shock-absorbing means of attachment or shock-absorbing complement for means of attachment according to this invention to be correctly installed and be able to be effective, its two minimum required equipped ends are designed to each be attached to a separate object, for example one end to a board and another end to the accommodating box or system, or one end to a component and the other end to a board, or one end to a board and the other equipped end attached to another board, or to link two components; together with all possible combinations either at an angle or in parallel.

The means of attachment or complement according to this invention can also be attached by its equipped ends to another separate means of attachment or to another separate specimen of this invention.

All inclination and angle openness arrangements are possible.

When the means of attachment or complement for a means of attachment according to this invention is installed, its two minimum required ends equipped for attachment are linked or attached to each other or dependent on each other only by way of a flexible part or parts located between these two minimum required equipped ends or which goes from one of these two minimum required equipped ends to the other.

This flexible part or parts can move or be moved without being detached from the two minimum required equipped ends once the means of attachment according to this invention has been installed.

The scale of these movements and displacements is dependent on the values of the dimension, hardness, density, resilience and elasticity factors of the flexible part and of the material or materials which constitute it.

In no case, and especially once the means of attachment according to this invention has been installed, does a rigid part participating in the attachment in a permanent way or a combination of rigid or flexible parts forming a rigid assembly compose a rigid section linking, firmly or otherwise, the two minimum required equipped ends, so as not to prevent their movements with respect to each other in all directions starting from their inert position.

That is to say that once installed in an attachment situation, the shock-absorbing means of attachment or shock-absorbing complement for a means of attachment according to this invention does not comprise or accommodate any part or combination of parts linking these two minimum required equipped ends which might prevent them from being moved with respect to each other in all directions starting from their inert position.

The movements which these two minimum required equipped ends can make with respect to each other when the means of attachment or complement according to this invention is installed may be of a short distance but in any event are clearly distinguished by their effectiveness from those which could be made by a rigid means of attachment which is loosely tightened or accompanied by a flexible part, such as a washer or a shim, for example.

This effectiveness can also result in a return of the two ends to the initial position after their movement, at a greater or lesser speed in proportion to the values of the resilience, hardness, density and dimension factors of the flexible part and of the material or materials which constitute it.

These movements and displacements which these two minimum required equipped ends can make with respect to each other starting from their inert position once the means of attachment or complement according to this invention is installed are visible to the naked eye and do not occur only at a microscopic level; they may nevertheless be of a distance smaller than, equal to or greater than one millimetre.

The fittings or separate groups of fittings specific to each of the two minimum required equipped ends are also linked to each other and from one end to the other only by a flexible part or parts and never by a part or set of parts forming a rigid part, except for those located on the same equipped end or which are part of the same group located on one of the two minimum required equipped ends.

According to specific modes of production, all end equipment combinations are possible, in order to offer for example an end equipped to accommodate and partly or wholly maintain a conventional or non-conventional means of attachment and a second end constituting in itself, by its shape, a conventional or non-conventional means of attachment.

Once installed, the means of attachment or complement for a means of attachment according to this invention offers its two minimum required equipped ends dependent on each other only by way of the flexible part or parts which link them or which go from one of these equipped ends to the other.

Once installed between, for example, a component or a circuit and component support board and a rigid wall, two specimens or more of this means of attachment according to this invention each have an end equipped to be easily attached to an attachment hole in the board or to the component and another end equipped to be easily attached to the rigid wall, by simply making holes in it.

We thus find ourselves with two separate groups of equipped ends depending on each other only by way of the flexible parts which link them.

The flexible part or parts linking these two minimum required equipped ends can make movements and therefore allow these two ends to be moved with respect to each other in all directions, which results in the taking up of the deformations transmitted from the box or system to which the component or the board to be secured is attached.

The shock-absorbing means of attachment or shock-absorbing complement according to this invention is shock-absorbing in the sense that once it is installed it follows or accompanies in part or in whole the shockwaves and deformations independently for each of its two minimum required equipped ends and for one with respect to the other.

The fittings located at the equipped ends may be constituted by a hole or holes, internal or external threads, retention notches and/or protuberances, parts which are compressed, hooks, retaining bars or any other conventional or non-conventional means of attachment, and by combinations of these elements; these fittings may also be or comprise housings designed to accommodate and maintain, in whole or in part, one or more conventional or non-conventional means of attachment.

By way of an example, the housings located at the equipped ends may be designed to accommodate and maintain a bolt, screw or rivet head, an eyelet, a whole nut, or a part which is compressed when it is inserted in the housing.

These housings may present an opening on the outside to facilitate the insertion of a conventional or non-conventional means of attachment, or part of the same.

Housings and holes can be made in communication.

These housings may accommodate the means of attachment for which they are designed in whole or in part at the time of the manufacturing of the means of attachment or complement according to this invention, for example in insertion during moulding, and may not comprise any opening on the outside other than that offered by the hole communicating with this housing.

The hole or holes positioned at the equipped ends enable the insertion and installation of a conventional or non-conventional means of attachment together with the insertion of a manipulating and tightening tool.

According to specific modes of production, the holes and housings located on the same equipped end or which are part of the same group of fittings of an end can be designed to accommodate and maintain part or all of a given means of attachment, for example, the head of a bolt in an equipped end housing and a part of the thread of this bolt passing through a hole in the same equipped end, the hole and housing being designed to be in communication.

The walls of the housing may be designed to move apart from each other when a means of attachment or a part of a means of attachment is installed in the housing.

This facilitates attachment and/or manipulation, as for example when additional turning means of attachment (nuts, bolts and other means) are used.

It is possible for example to envisage a housing produced with dimensions smaller than those of the means of attachment or part of a means of attachment which will be inserted in this housing, as its walls can be designed like the flexible part in an elastic and resilient material. The dimensions of the housing can therefore be stretched during the insertion and installation of the additional means of attachment. The walls thus stretched are tautened and as their composition is elastic and resilient they tend to return to their shape and tighten around the contours of the means of attachment installed in the housing.

The same applies to the walls of the perimeters of the holes, which can also be designed to move apart from each other when a means of attachment is partly or wholly inserted in these holes or when a manipulating and tightening tool is inserted in them.

The holes or openings positioned at the equipped ends can be designed to maintain by themselves part or all of an additional or separate means of attachment, for example by extension and/or compression of their circumference or perimeter.

This additional means of attachment may for example be already installed on the box or system housing the component or the board to be attached.

A part or parts which is/are compressed when made to pass through an attachment hole may be placed at each or at only one of the two minimum required equipped ends and constitute or complement an end fitting.

At each equipped end, a hook or hooks and/or one or more retaining bars or rods for hooks can be fitted.

These retaining hooks and bars can be designed to be of such a shape that they can be compatible with each other for attachment to each other, for example a hook with a retaining bar or a hook with another hook.

These hooks and retaining bars may comprise a “tightening” boss or bosses on themselves or in their immediate environment.

These tightening bosses can be designed to be placed on the surface of a separate object or of another specimen of the means of attachment according to this invention.

These hooks can be designed to be of such a shape that they can pass through an attachment hole, whether this hole is on a board, a component, a separate means of attachment, an accommodating box or system or a wall, and be placed on a surface close to this hole and/or surrounding it; they can also be designed so that they can, after passing through an attachment hole, partly or wholly surround a retaining rod or bar which may be, for example, that of a separate means of attachment or of another specimen of the means of attachment according to this invention.

This hook may comprise one or more centred or eccentric “tightening” bosses.

This hook may be designed to partly or wholly surround a retaining rod or bar located on a separate part or on a separate means of attachment.

These hooks and retaining bars may be designed to be of such a shape that a hook can also have the properties of a retaining bar and therefore be able to be attached both to another hook and to a retaining bar.

These hooks can be designed to be inserted wholly or partly in a housing or housings located on an equipped end and/or in a hole or holes in a separate means of attachment.

At each minimum required equipped end it is possible to make or position a “retention” notch or notches and/or protuberance or protuberances which can be blocked against the protuberance or protuberances and/or notches of a separate similar or different part, or against a simple wall after for example passing through the wall by one of these notches. If necessary a rotation of the equipped end may be envisaged. This rotation can be carried out inside the attachment opening of a separate part, or on the perimeter of a separate attachment part.

These notches and protuberances can be made oriented towards the outside or the inside of the means of attachment according to this invention.

These retention notches and protuberances may be positioned on the outer surface of the means of attachment according to this invention and/or inside a housing or hole in an equipped end.

These notches and protuberances may be placed on a moving part or parts; these moving parts may make one or more rotation and/or translation and/or pivoting movements.

These moving parts may be equipped with an internal or external thread and/or any other end fitting.

These end fittings constituted by the holes, threads, conventional or non-conventional means of attachment, parts which are compressed, notches and protuberances, hooks, bars and housing placed at the equipped ends can be made oriented at an angle with respect to each other and from one equipped end to another, whatever the degree of openness of this angle, or in parallel, to allow attachment at an angle or in parallel.

The end fittings may be positioned on a moving part or parts which can be designed to be mobile in all directions, whether in rotation and/or in translation and/or on a pivot and/or dissociated and added and/or attached and detached.

An internal passage passing through the flexible part, or the flexible part and at least one of the ends, whether this end is equipped or not, may be made to allow the insertion of a manipulating and tightening tool, such as a screwdriver, for example, and allow the insertion of an additional means of attachment in order, for example, to facilitate its installation at an equipped end.

This internal passage may be hollow and/or comprise walls which move apart from each other on the insertion of a manipulating and tightening tool or of an additional means of attachment.

The internal passage or passages passing through the flexible part or parts do not prevent this flexible part or these flexible parts from moving once the means of attachment or complement according to this invention is installed.

The internal passage or passages passing through the flexible part or parts do not prevent the two minimum required ends from being moved with respect to each other in all directions with respect to an inert position, once the means of attachment according to this invention has been installed.

The holes, internal threads, housings and internal passages can be made in communication to facilitate their use and enable the insertion of a manipulating and tightening tool and/or the insertion of an additional means of attachment, whether conventional or non-conventional.

A simple mode of production may use a tab made of flexible material with two useful holes made in it.

These two useful holes or openings may be passed through by one or more conventional or non-conventional means of attachment, such as a screw or a bolt, for example.

In this rudimentary case, the two holes can be brought closer to each other and constitute the fittings of a single end while the end of the loop formed by the folded tab constitutes the fitting of the second minimum required end.

Particularly in this case, but not solely, it may be useful to provide an attachment perimeter greater than that of the board or component to be attached.

A more sophisticated mode of production uses a flexible material, which may be elastic and resilient, such as, to give a non-limitative example, moulded polyurethane of Shore hardness 70.

Whatever the material or materials used to manufacture the flexible part or the means of attachment or complement according to this invention, care shall be taken to combine their resilience, elasticity, hardness, dimension and density factors in order, in accordance with the weight of the components and or the support board, to obtain an appropriate balance between firm support and total flexibility, and thus enable the minimum required ends to be moved with respect to each other in all directions with respect to their inert position in an attachment situation.

The flexible part may be made of metal and have the shape or a cylindrical or non-cylindrical spring.

The flexible part located between the ends may be made of an electrically conducting material, which allows for example ground connections.

When the flexible part is made of an electrically non-conducting material, it may be useful to join an electrically conducting flexible part, such as a flexible cable for example, in order not to hinder the movements of the flexible part linking two equipped ends of the shock-absorbing means of attachment according to this invention.

The appended drawings illustrate the invention:

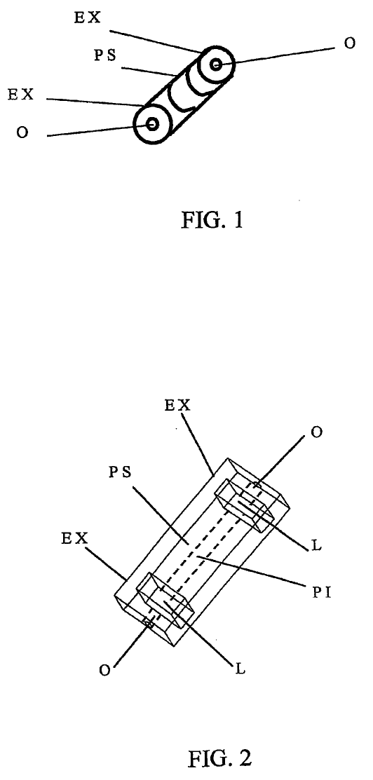

FIG. 1 shows the means of attachment according to this invention made of a flexible material such as moulded polyurethane of Shore hardness 70, for example, comprising a flexible part (PS) between its ends (EX). Two of its ends (EX) each comprise a hole (O).

The open cylinder shape allows the insertion and installation of additional means of attachment, whether conventional or non-conventional, together with the insertion of a manipulating and tightening tool.

FIG. 2 shows in a transparent view the means of attachment according to this invention made of a flexible material which may be PU 70. It comprises a flexible part (PS) located between its ends (EX). At each of the two ends (EX) there is a hole (O) and a housing (L) which are oriented in parallel to each other. The flexible part (PS) is passed through by an internal passage (PI). The holes (O), the housings (L) and the internal passage (PI) are in communication.

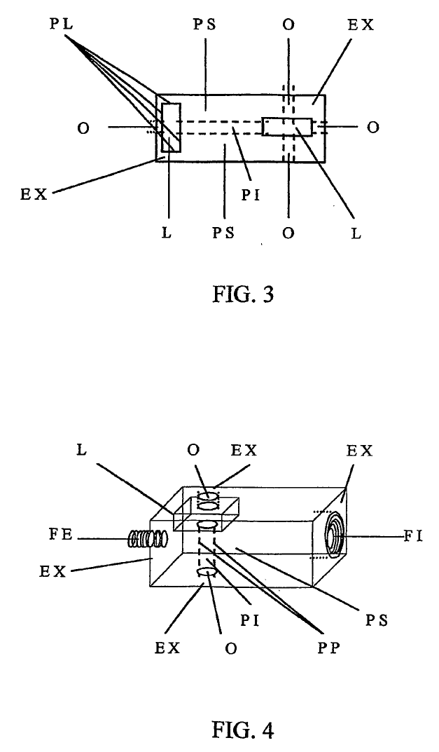

FIG. 3 shows in a profile view the means of attachment according to this invention made of a flexible material which may be PU 70. It comprises a flexible part (PS) between its ends (EX). The ends (EX) are equipped with a housing (L) and/or a hole (O). The housings (L) each comprise walls (PL) which move apart from each other when a means of attachment is installed in this housings (L). For this purpose, the dimensions of these housings (L) are smaller than those of the means of attachment intended to be installed in them. An internal passage (PI) passes through the flexible part (PS). The holes (O), the housings (L) and the internal passage (PI) are in communication. The holes (O) are oriented either at an angle or in parallel to each other, and the two housings (L) are oriented at an angle to each other.

FIG. 4 shows in a transparent view the means of attachment according to this invention made moulded in a flexible material, which may be polyurethane, in which are inserted during moulding two threads which may be made of metal, one internal (FI) and the other external (FE). Each of the two threads (FI, FE) is located at an end (EX), and the flexible part (PS) is located between the ends (EX). Two holes (O) are oriented in parallel with each other and each placed at one end (EX). An internal passage (PI) passes through the flexible part (PS). The walls (PP) of the internal passage (PI), which are also made of flexible material, move apart from each other on insertion of a tool of dimensions greater than those of the internal passage (PI). The holes (O), the housing (L) and the internal passage (PI) are in communication.

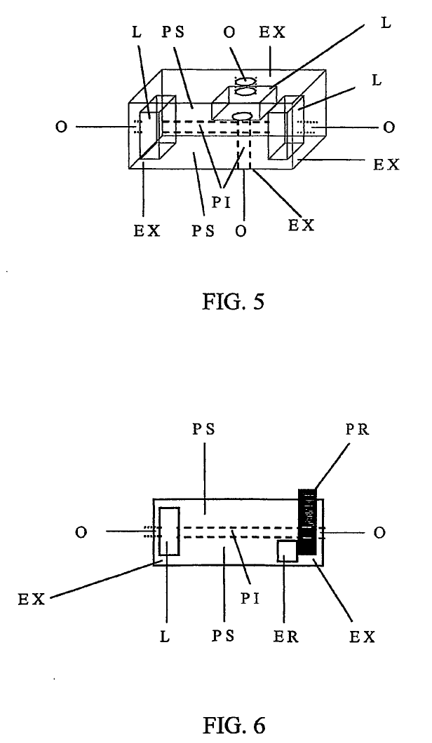

FIG. 5 shows in a transparent view the means of attachment according to this invention which may be made in one piece in a flexible material such as moulded polyurethane. It comprises a flexible part (PS) located between its ends (EX). Four of its ends (EX) each have a hole (O), and three of its ends (EX) each have a housing (L). Two internal passages (PI) pass through the flexible part (PS). The holes (O), the housings (L) and the internal passages (PI) are in communication. The holes (O) and the housings (L) are oriented in some cases at an angle and in other cases in parallel to each other.

FIG. 6 shows in a profile view a version which may be moulded in one piece, for example in polyurethane, comprising two equipped ends (EX) linked to each other by a flexible part (PS). Its two equipped ends (EX) comprise in one case a housing (L) and a hole (O) and in the case of the second equipped end (EX) a retention protuberance (PR), a retention notch (ER) and a hole (O). An internal passage (PI) passes through the flexible part (PS). The holes (O), the housing (L) and the internal passage (PI) are in communication.

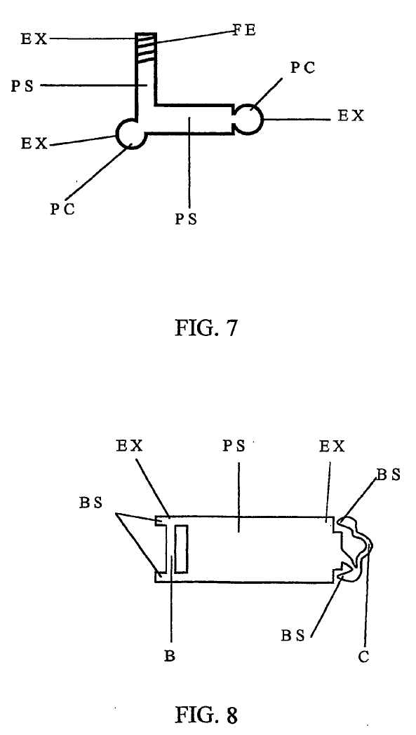

FIG. 7 shows in a profile view a version comprising three equipped ends (EX), one of which comprises an external thread (FE). A second and a third equipped end (EX) each comprise a part which is compressed (PC) when it is made to pass through an attachment hole. These equipped ends are linked two by two to each other only by the flexible part or parts (PS) located between them.

FIG. 8 shows in a profile view a version which may be made moulded in polyurethane, while the hook (C) and the retaining bar (B) may made of another material and inserted at the time of manufacture. This version comprises on one of its minimum required equipped ends (EX) a hook (C) equipped with two tightening bosses (BS), and on its second its second equipped end (EX) a retaining bar (B) and two tightening bosses (BS); in this version the hook (C) may pass through an attachment hole, in a board for example, and be positioned by means of its two tightening bosses (BS) on the surface surrounding this attachment hole; this hook (C) may or may not at the same time surround the retaining bar (B) of a separate means of attachment or of a separate specimen of this invention. This retaining bar (B) may be surrounded by a tightening boss or bosses (BS) which may be positioned on the hook (C) of a separate means of attachment or of a separate specimen of this invention or on the surface surrounding an attachment hole, for example in a board.

The means of attachment or complement according to this invention may, according to its various versions, be produced in a single piece or by combinations of parts of different or similar materials.

In reference to these drawings the means of attachment or complement according to this invention comprises at least two equipped ends (EX), including at least one to be attached to a board or a component and at least one other to be attached to the box or system accommodating this board or this component or to another board or another component.

Once equipped and installed, these two equipped ends (EX) are dependent on each other only by way of the flexible part (PS) located between them which links them.

All combinations of equipped ends and end fittings are possible to constitute the two minimum required equipped ends.

The part located between these two minimum required equipped ends is flexible and therefore requires that no rigid part or combination of parts forming a rigid assembly link these two ends, especially once this invention is installed in an attachment situation. The flexible part allows these two ends to be moved with respect to each other in all directions starting from their inert position.

We thus obtain the taking up, by the means of attachment or complement for a means of attachment according to this invention, of the deformations transmitted from the box or system housing the component or board to be attached.

These equipped ends are designed to accommodate simultaneously, and each independently, one or more conventional or non-conventional means of attachments, or are themselves conventional or non-conventional means of attachment. These fittings consist in their simplest version of a hole, threaded or otherwise.

In the use of a version comprising an internal passage, care shall be taken to choose the dimensions of the additional means of attachment in such a way that these means of attachment do not pass through the flexible part in a permanent way. For example, in FIG. 2, if the two housings (L) each accommodate a nut parallel to the other one and perpendicular to the internal passage (PI), the additional bolts which, in each passing through a hole (O), will each come into a nut, must have a length which does not allow them to pass through the flexible part (PS) and meet, whether or not through the internal passage, once the means of attachment or complement according to this invention is installed.

In general, with or without an internal passage, care shall be taken to choose additional means of attachment which disturb, modify or reduce the elastic properties of the flexible part only if it is required that they be modified and/or reduced, for example by compressing the flexible part.

The shock-absorbing means of attachment for components and printed circuit and component support boards according to this invention is particularly designed to reduce the risks of breakdown for electrical and electronic systems while at the same time offering attachment performances necessary for industry.

1) Shock-absorbing means of attachment for components and printed circuit and component support boards, characterised by the fact that it comprises at least two ends (EX) each equipped for attachment to a separate object; these two ends (EX) each comprise one of the following elements;
an internal thread (FI),
en external thread (FE),
a housing (L) to accommodate and maintain one or more conventional or non-conventional means of attachment,
a part which is compressed (PC) when it passes through an attachment hole,
a retention protuberance or protuberances (PR),
a retention notch or notches (ER),
a hook (C),
a retaining bar (B) for hook,
and characterised by the fact that once installed in an attachment situation these two ends (EX) each attached to a separate object are linked to each other only by the flexible part (PS) located between them, and not by a rigid part or combination of parts constituting a rigid assembly:
This flexible part (PS) enables these two equipped ends (EX) to be moved with respect to each other in-all directions.

2) Shock-absorbing means of attachment in accordance with claim 1 characterised by the fact that it comprises an internal passage (PI) passing through the flexible part (PS). This internal passage (PI) allows the insertion of a manipulating and tightening tool and/or a means of attachment.

3) Shock-absorbing means of attachment in accordance with claim 1 characterised by the fact that the housing (L) comprises walls (PL) which move apart from each other when a means of attachment is installed in the housing (L).

4) Shock-absorbing means of attachment in accordance with claim 2 characterised by the fact that the internal passage (PI) comprises walls (PP) which move apart from each other when a manipulating and tightening tool or a means of attachment is inserted in the internal passage (PI).

5) Shock-absorbing means of attachment in accordance with claim 1 or claim 3 characterised by the fact that the threads (FI, FE), parts which are compressed (PC), retention protuberances (PR), retention notches (ER), hooks (C), retaining bars (B) and housings (L) located at the equipped ends (EX) are oriented at an angle to each other.

6) Shock-absorbing means of attachment in accordance with claim 1 or claim 3 characterised by the fact that the threads (FI, FE), parts which are compressed (PC), retention protuberances (PR), retention notches (ER), hooks (C), retaining bars (B) and housings (L) located at the equipped ends (EX) are oriented in parallel to each other.

7) Shock-absorbing means of attachment in accordance with any one of the previous claims characterised by the fact that a housing or housings (L), an internal thread or threads (FI) and an internal passage or passages (PI) are in communication with each other or among themselves in pairs or more.

8) Shock-absorbing means of attachment in accordance with one of claims 1, 5 or 6 characterised by the fact that the hook (C) and the retaining bar (B) comprise, on themselves on in their immediate environment, a tightening boss (BS).

9) Shock-absorbing means of attachment in accordance with one of claims 1, 5, 6 or 8 characterised by the fact that the hook (C) and the retaining bar (B) are compatible with each other for attachment to each other.

10) Shock-absorbing means of attachment in accordance with claim 1 or claim 2 characterised by the fact that the flexible part (PS) linking the two minimum required equipped ends (EX) is electrically conductive.

11) Shock-absorbing means of attachment in accordance with claim 1 characterised by the fact that a hole (O) complements or replaces a housing (L).
